(19) United States
(12) Patent Application Publication
(10) Pub. No.: US 2012/0117480 A1
(43) Pub. Date: May 10, 2012

(54) System and Method for Locating Document Processing Devices

(75) Inventors: Ashish Khandelwal, Laguna Hills, CA (US); Amir Shahindoust, Laguna Niguel, CA (US)

(73) Assignees: Toshiba Tec Kabushiki Kaisha, Tokyo (JP); Kabushiki Kaisha Toshiba, Tokyo (JP)

(21) Appl. No.: 12/941,789

(22) Filed: Nov. 8, 2010

(51) Int. Cl. G06F 3/048; G06F 17/30

(52) U.S. Cl. 715/738

(57) ABSTRACT

The subject application is directed to a system and method for locating a document processing device. Device data corresponding to the physical location of a plurality of uniquely identified document processing devices is stored in a location data storage device coupled to a location server. A user device obtains user location data corresponding to a physical location of a user. The user device receives, via user interface, a user query for a location of at least one document processing device. The user device sends the user location data and the query to the location server. The location server generates document processing device list data based upon a comparison of the user location data and the device data. The user device displays the document processing device list data on the user interface.

### BACKGROUND

1. Field

The subject application is directed generally to location of document processing devices. The application is particularly directed to providing users a list of available document processing device as well as information as to their status to assist in choosing a networked device for a document processing operation.

2. Description of the Related Art

Document processing devices include copiers, printers, facsimile machines, scanners or e-mail gateways. More recently, devices include two or more of these functions, and are referred to as multifunction peripherals (MFPs) or multifunction devices (MFDs). A larger enterprise will typically include two or more MFPs, which are connected either wired or wirelessly with other devices, such as computers, workstations, or servers, via a data network.

When a user needs to process documents, the user may not be aware of which devices are available. The user may be new to a particular location, and may select a device that is not physically convenient to the user's position. Further, even if a user is familiar with their document processing device options, they may select a device that is currently busy or not functional for their intended use.

### DESCRIPTION OF THE DRAWINGS

FIG. 1 is an overall diagram of a system for locating document processing devices according to one embodiment of the subject application.

FIG. 2 is a block diagram illustrating device hardware for use in the system for locating document processing devices according to one embodiment of the subject application.

FIG. 3 is a functional diagram illustrating the device for use in the system for locating document processing devices according to one embodiment of the subject application.

FIG. 4 is a block diagram illustrating controller hardware for use in the system for locating document processing devices according to one embodiment of the subject application.

FIG. 5 is a functional diagram illustrating the controller for use in the system for locating document processing devices according to one embodiment of the subject application.

FIG. 6 is a functional diagram illustrating a server for use in the system for locating document processing devices according to one embodiment of the subject application

FIG. 7 is a functional diagram illustrating a workstation for use in the system for obtaining address data from a portable device to a document processing device according to one embodiment of the subject application.

FIG. 8 is a block diagram illustrating the system for locating document processing devices according to one embodiment of the subject application.

FIG. 9 is a functional diagram illustrating the system for locating document processing devices according to one embodiment of the subject application.

FIG. 10 is a flowchart illustrating a method for locating document processing devices according to one embodiment of the subject application.

FIG. 11 is a flowchart illustrating a method for locating document processing devices according to one embodiment of the subject application.

FIG. 12 is a flowchart illustrating a method for configuring document processing devices for location in accordance with one example embodiment of the subject application.

FIG. 13 is a flowchart illustrating a method for locating the configured document processing devices according to one example embodiment of the subject application.

### DETAILED DESCRIPTION

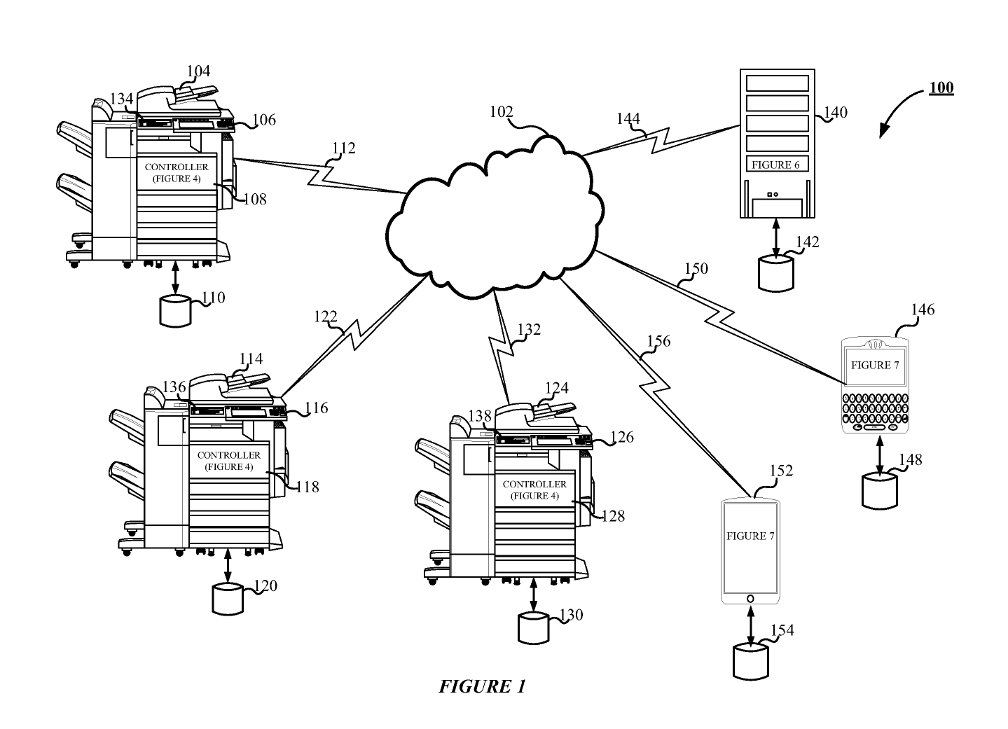

The subject application is directed to a system and method for locating document processing devices. The application is particularly directed to providing to users a list of available document processing device as well as information as to their status to assist in choosing a networked device for a document processing operation. It will become apparent to those skilled in the art that the system and method described herein are suitably adapted to a plurality of varying electronic fields employing automated configuration, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for locating document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document rendering services to external or network devices. According to one embodiment of the subject application, the document processing devices 104, 114, and 124 include hardware, software, and any suitable combination thereof, configured to interact with an associated user, a networked device, or the like. Preferably, the document processing devices 104, 114, and 124 are capable of communicating electronic documents to and from each other in accordance with user provided instructions, transferring electronic documents amongst each other based upon output capabilities, locations, or the like.

According to one embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

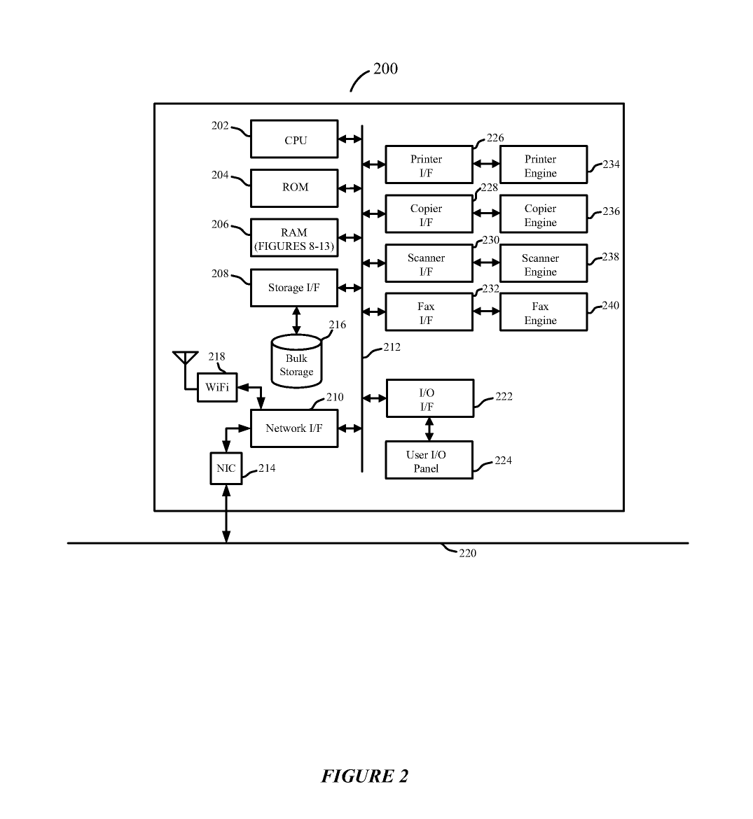

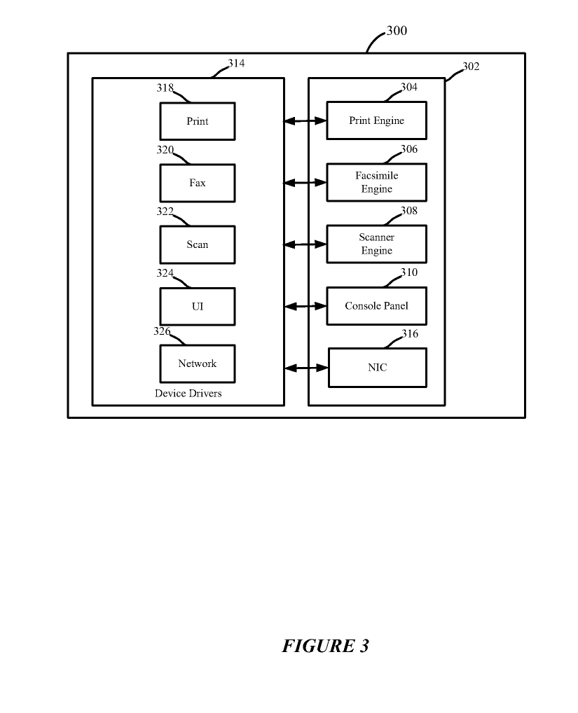

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

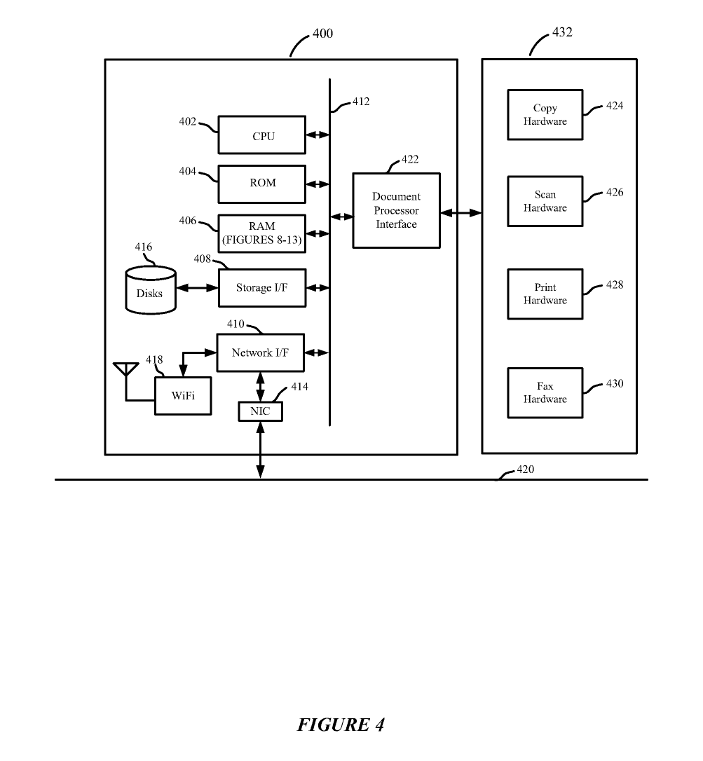

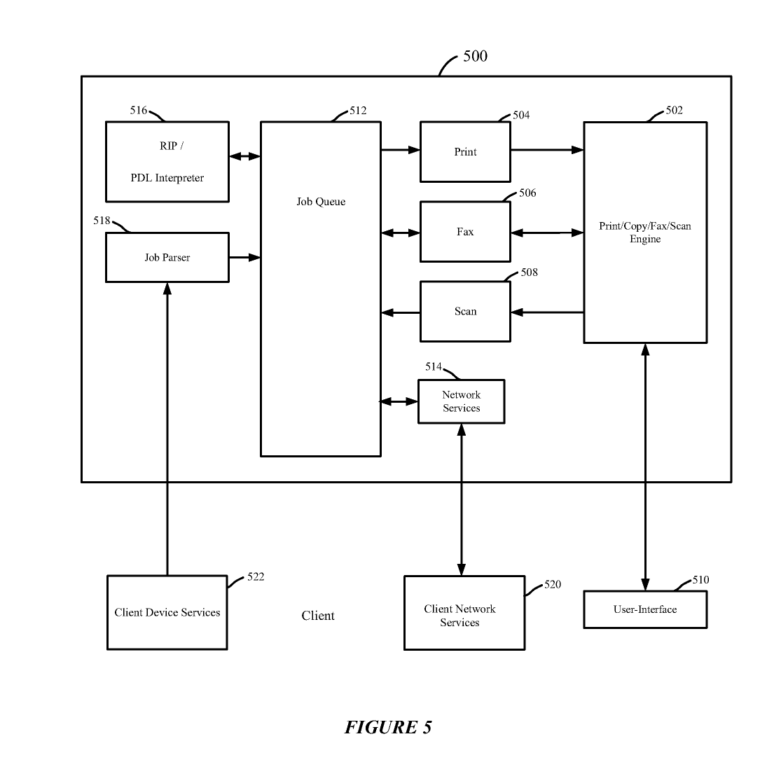

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for integrating operation of systems employing distinct authentication of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like. The document processing devices 104, 114, and 124 of FIG. 1 also include portable storage device readers 134, 136, and 138, respectively, which are suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a backend component, shown as the location server 140, in data communication with the computer network 102 via a communications link 144. It will be appreciated by those skilled in the art that the server 140 is shown in FIG. 1 as a component of the system 100 for example purposes only, and the subject application is capable of implementation without the use of a separate backend server component, e.g. the server 140 is capable of implementation via the document processing devices 104, 114, or 124. The skilled artisan will appreciate that the server 140 comprises hardware, software, and combinations thereof suitably adapted to provide one or more services, web-based applications, user authentication verification, storage options, and the like, to networked devices. In accordance with one example embodiment of the subject application, the server 140 includes various components, implemented as hardware, software, or a combination thereof, for authenticating user information, managing workflow, managing retention of documents, processing text data, performing searches, performing comparisons, maintaining database entries, account information, receiving payment data, retrieval of documents, and the like, which are accessed via the computer network 102.

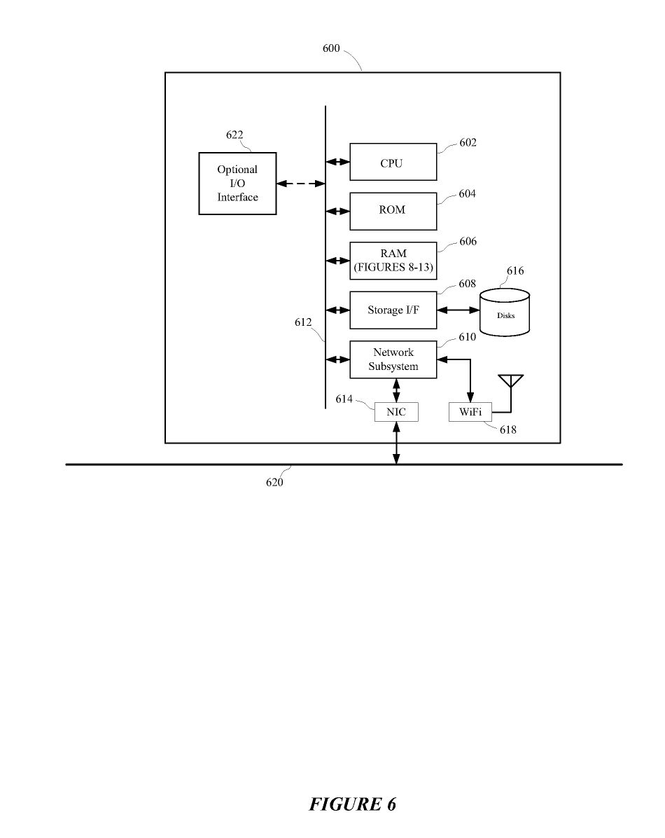

The communications link 144 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 140 are capable of implementation on any suitable computing device coupled to the computer network 102, e.g. the controllers 108, 118, or 128, or the like. The functioning of the server 140 will better be understood in conjunction with the block diagram illustrated in FIG. 6, explained in greater detail below.

Communicatively coupled to the server 140 is the data storage device 142. According to the foregoing example embodiment, the data storage device 142 is any mass storage device, or plurality of such devices, known in the art including, for example and without limitation, magnetic storage drives, a hard disk drive, optical storage devices, flash memory devices, or any suitable combination thereof. In such an embodiment, the data storage device 142 is suitably adapted to store user information, database information, document processing device information, application data, a document management system data, electronic documents, tag data, positioning data, layout data, and the like. It will be appreciated by those skilled in the art that while illustrated in FIG. 1 as being a separate component of the system 100, the data storage device 142 is capable of being implemented as internal storage components of the server 140, or the like, such as, for example and without limitation, an internal hard disk drive, or the like.

Also depicted in FIG. 1 is a plurality of user devices, illustrated as portable telecommunications devices 146 and 152. Each portable telecommunications device 146 and 152 is preferably in data communication with the document processing device 104 via corresponding communications links 150 and 156. It will be appreciated by those skilled in the art that the portable telecommunication devices 146 and 152 are shown in FIG. 1 as a smart cellular telephone and a portable electronic mail device for illustration purposes only. As will be understood by those skilled in the art, the portable telecommunication devices 146 and 152 are representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the portable telecommunication devices 146 and 152 further include software, hardware, or a suitable combination thereof configured to interact with the document processing device 104 or the like. Preferably, each portable telecommunication device 146 and 152 includes a suitable personal area network interface, such as a BLUETOOTH transceiver, an RF transceiver, and the like.

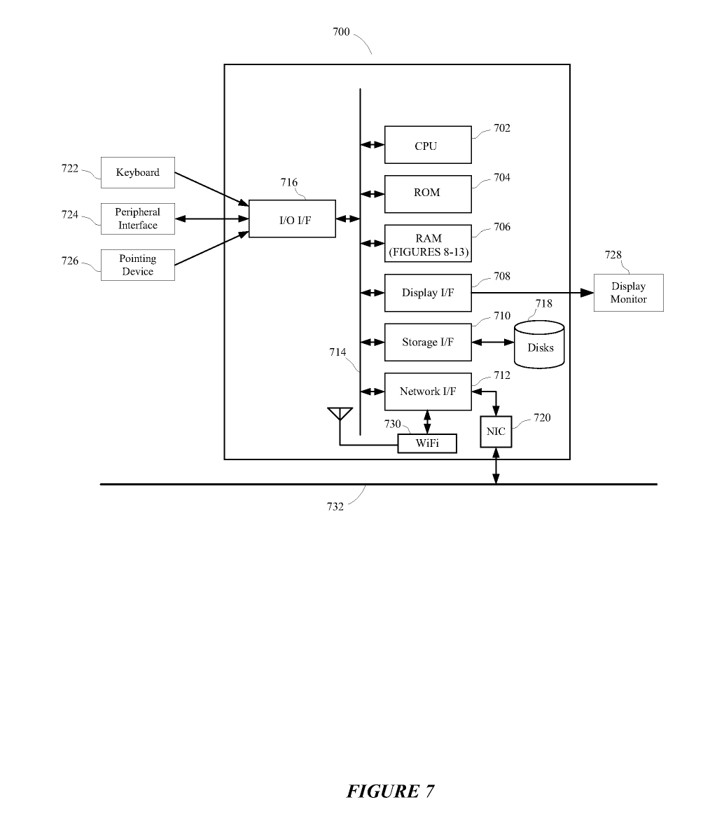

The communications links 150 and 156 are any suitable channel of data communications known in the art including, but not limited to wireless communications, for example and without limitation, BLUETOOTH, WiMax, 802.11a, 802.11b, 802.11g, 802.11(x), a proprietary communications channel, infrared, optical, the public switched telephone network, or any suitable wireless data transmission system, or wired communications known in the art. Preferably, the portable telecommunication devices 146 and 152 are suitably adapted to provide contact information, address book data, document data, job data, user interface data, image data, monitor document processing jobs, employ thin-client interfaces, generate display data, generate output data, or the like, with respect to the document processing device 104, or any other similar device with which the portable telecommunication devices 146 and 152 are capable of communicating. According to one embodiment of the subject application, the portable telecommunication devices 146 and 152 are capable of implementing various graphical user interface applications for interacting with a user, as will be appreciated by those skilled in the art to include a physical keyboard, a soft keyboard via an associated touch screen interface, or a suitable combination thereof. The functioning of the portable telecommunication devices 146 and 152 will better be understood in conjunction with the block diagram illustrated in FIG. 7, explained in greater detail below.

Communicatively coupled to the portable telecommunication devices 140 and 146 are data storage devices 148 and 154, respectively. According to the foregoing example embodiment, the data storage devices 148 and 154 are any mass storage device, or plurality of such devices, known in the art including, for example and without limitation, magnetic storage drives, a hard disk drive, optical storage devices, flash memory devices, or any suitable combination thereof. In such an embodiment, the data storage devices 148 and 154 are suitably adapted to store operating systems, address book data, personal information, account information, identification data, regional data, thin client interface data, keyboard layout data, keyboard property data, HTML keyboard data, JavaScript keyboard data, update software, policy information, and the like. It will be appreciated by those skilled in the art that while illustrated in FIG. 1 as being a separate component of the system 100, the data storage devices 148 and 154 are capable of being implemented as an internal storage component of the portable telecommunication devices 146 and 152.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (depicted in FIG. 1 as the location server 140), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

Turning now to FIG. 7, illustrated is a hardware diagram of a suitable workstation 700, shown in FIG. 1 as the portable telecommunication devices 146 and 152, for use in connection with the subject system. A suitable workstation includes a processor unit 702 which is advantageously placed in data communication with read only memory 704, suitably non-volatile read only memory, volatile read only memory or a combination thereof, random access memory 706, display interface 708, storage interface 710, and network interface 712. In a preferred embodiment, interface to the foregoing modules is suitably accomplished via a bus 714.

The read only memory 704 suitably includes firmware, such as static data or fixed instructions, such as BIOS, system functions, configuration data, and other routines used for operation of the workstation 700 via CPU 702.

The random access memory 706 provides a storage area for data and instructions associated with applications and data handling accomplished by the processor 702.

The display interface 708 receives data or instructions from other components on the bus 714, which data is specific to generating a display to facilitate a user interface. The display interface 708 suitably provides output to a display terminal 728, suitably a video display device such as a monitor, LCD, plasma, or any other suitable visual output device as will be appreciated by one of ordinary skill in the art.

The storage interface 710 suitably provides a mechanism for non-volatile, bulk or long term storage of data or instructions in the workstation 700. The storage interface 710 suitably uses a storage mechanism, such as storage 718, suitably comprised of a disk, tape, CD, DVD, or other relatively higher capacity addressable or serial storage medium.

The network interface 712 suitably communicates to at least one other network interface, shown as network interface 720, such as a network interface card, and wireless network interface 730, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 720 is interconnected for data interchange via a physical network 732, suitably comprised of a local area network, wide area network, or a combination thereof.

An input/output interface 716 in data communication with the bus 714 is suitably connected with an input device 722, such as a keyboard or the like. The input/output interface 716 also suitably provides data output to a peripheral interface 724, such as a USB, universal serial bus output, SCSI, Firewire (IEEE 1394) output, or any other interface as may be appropriate for a selected application. Finally, the input/output interface 716 is suitably in data communication with a pointing device interface 726 for connection with devices, such as a mouse, light pen, touch screen, or the like.

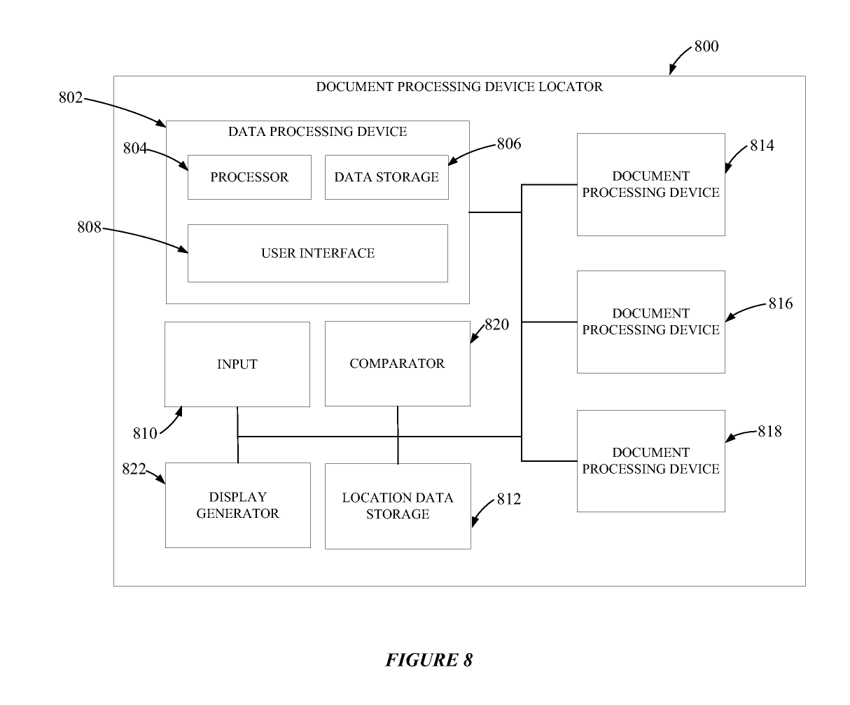

Referring now to FIG. 8, illustrated is a block diagram of a document processing device locator 800 in accordance with one embodiment of the subject application. The document processing device locator 800 of FIG. 8 includes a data processing device 802 that has a processor 804, a data storage 806, and a user interface 808. The locator 800 further includes an input 810, a location data storage 812, a comparator 820, and a display generator 822. The input 810 of the locator 800 of FIG. 8 is configured to receive user location data that corresponds to the physical location of the data processing device 802. The location data storage 812 includes device data that corresponds to the physical location of each of a plurality of uniquely identified document processing devices 814, 816, 818.

According to one embodiment of the subject application, the user interface 808 is operable to receive query data that corresponds to a query for the location of at least one of the document processing devices 814, 816, 818. The comparator 820 of the locator of FIG. 8 is configured to respond to the query data such that the comparator 820 generates document processing device list data based upon a comparison of the user location data and the device data. The document processing device locator 800 includes the display generator 822 for the generation of an output that represents the document processing device list data on the user interface 808.

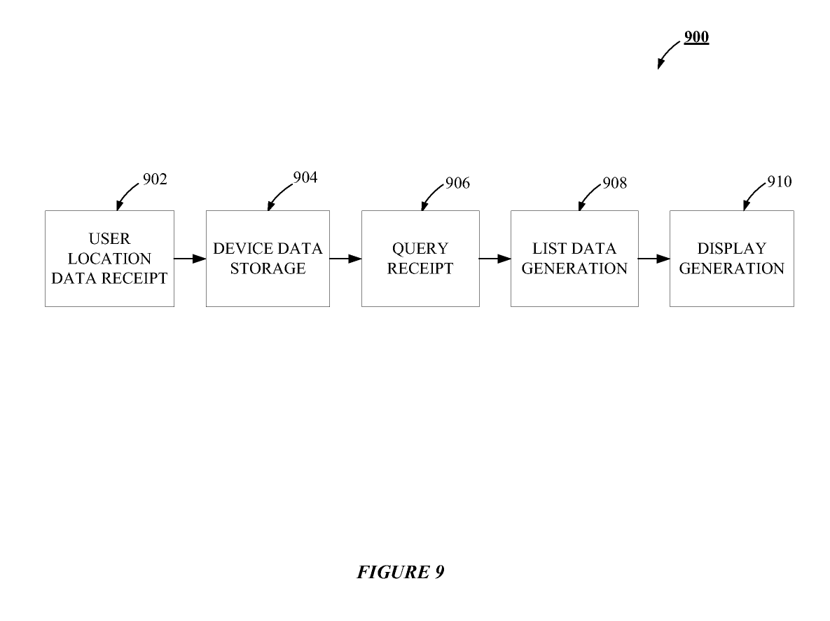

Turning now to FIG. 9, illustrated is a functional diagram of a system 900 for document processing device location in accordance with one embodiment of the subject application. As shown in FIG. 9, user location data receipt 902 first occurs of data representing the physical location of the user into a data processing device. Preferably, the data processing device includes, for example and without limitation, a processor, a data storage, and a user interface. Device data storage 904 is then performed of device data that corresponds to a physical location of each of a plurality of uniquely identified document processing devices in a location data storage.

Query receipt 906 then occurs via the user interface for a location of at least one of the document processing devices. List data generation 908 is performed in response to the query receipt 906 based upon a comparison of the user location data and the device data. Display generation 910 is then performed of a display on the user interface representing the document processing list data.

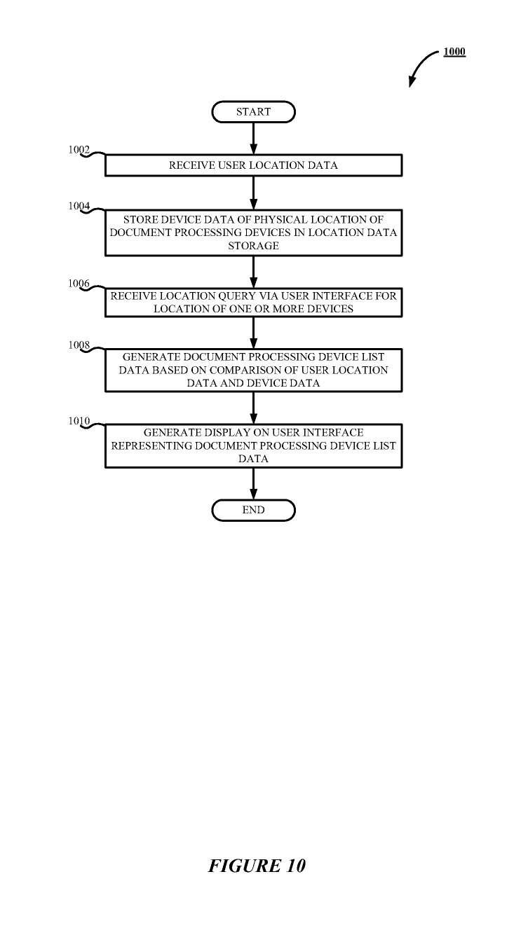

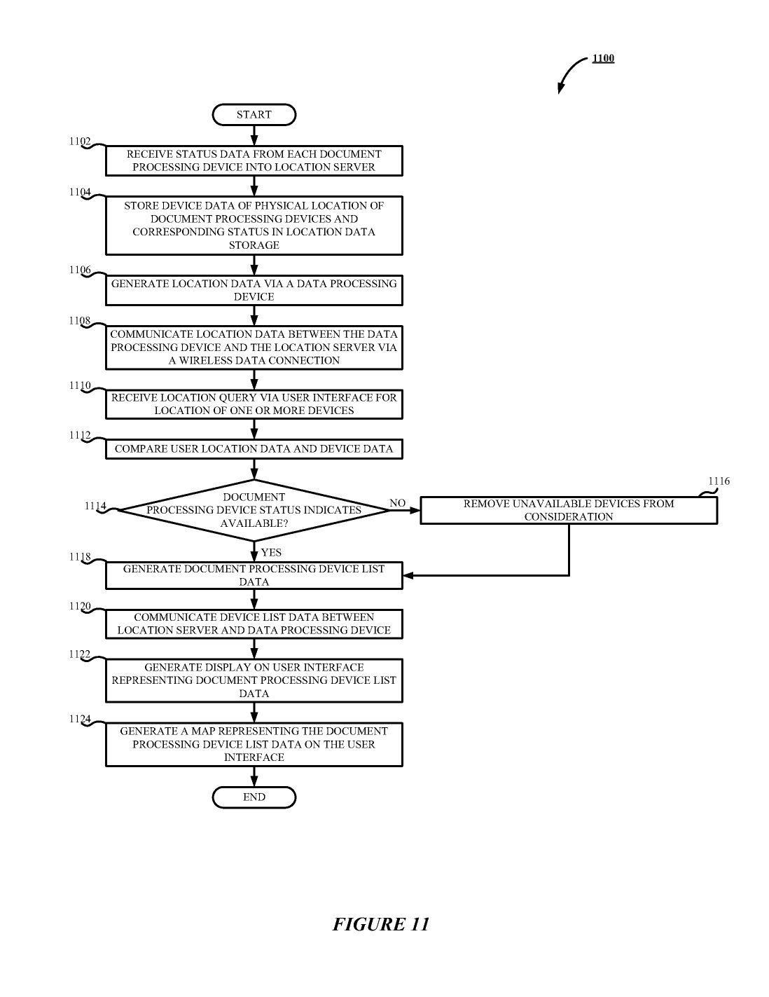

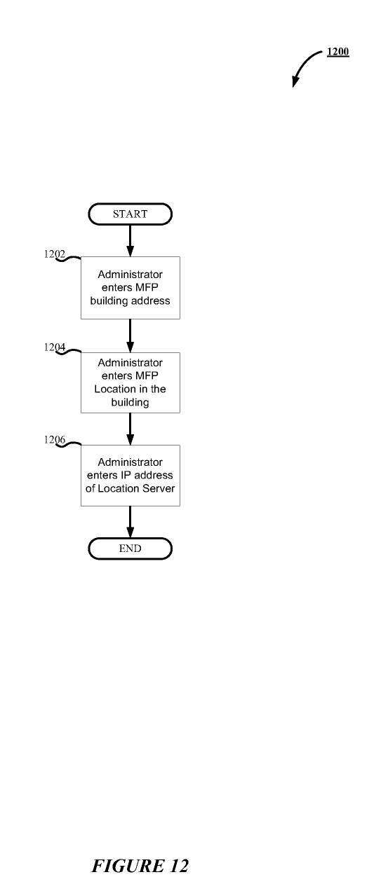

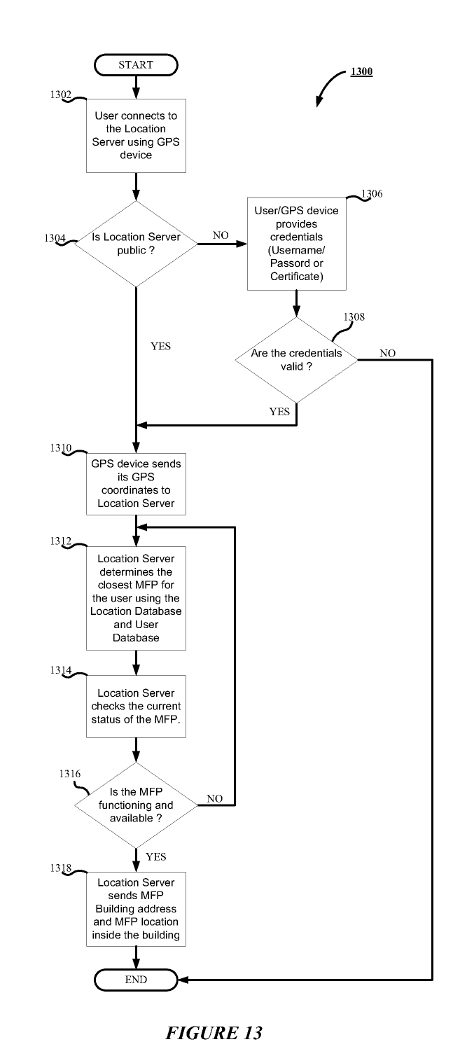

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example illustrations of the embodiments depicted in FIG. 12 and FIG. 13. Turning now to FIG. 10, there is shown a flowchart 1000 illustrating a method for document processing device location in accordance with one embodiment of the subject application. Beginning at step 1002, receiving user location data is received into a data processing device. According to one embodiment of the subject application, the data processing device includes a processor, data storage, and a user interface.

Device data is then stored in a location data storage at step 1004. Preferably, this device data corresponds to the physical location of each of a plurality of uniquely identified document processing devices. At step 1006, a query is received via the user interface for the location of one or more of the document processing devices. Document processing device list data is then generated at step 1008 in accordance with a comparison of the user location data and the device data. A display is thereafter generated at step 1010 on the user interface representative of the document processing device list data.

Referring now to FIG. 11, there is depicted a flowchart 1100 illustrating a method for document processing device location in accordance with one example embodiment of the subject application. The methodology of FIG. 11 begins at step 1102, whereupon status data is received from each of the available document processing devices 104, 114, and 124 corresponding to the operational status of each device 104, 114, and 124 relative to document processing operations into the location server 140. The status information, along with device data corresponding to the physical location of each of the document processing devices 104, 114, and 124 is then stored in the data storage 142 associated with the location server at step 1104. In accordance with one embodiment of the subject application, the device data includes, for example and without limitation, the network address of the devices 104, 114, 124, the address of the building in which the device 104, 114, or 124 resides, the floor in the building, facsimile number, and other useful location identifying indicia, as will be appreciated by those skilled in the art.

At step 1106, user location data is generated by a data processing device, e.g. the portable telecommunication device 146 or 152. According to one example embodiment, the user location data corresponds to the global positioning system (GPS) coordinates generated by the portable telecommunication device 146 or 152 with which the user is associated. The skilled artisan will appreciate that other suitable methods of coordinate determination are also capable of being used in accordance with the subject methodology of FIG. 11. At step 1108, the location data is communicated from the portable telecommunication device 146 or 152 to the location server 140 via a wireless data connection. The wireless data connection includes, for example and without limitation, cellular data channels, proprietary data channels, wireless Internet channels, RF channels, or the like.

According to one example embodiment of the subject application, a location query for available document processing devices 104, 114, and/or 124 is received via the user interface associated with one of the data processing devices, i.e. the portable telecommunication devices 146 or 152 at step 1110. For purposes of example only, reference is made hereinafter to the data processing device 146 as the device with which the user is interacting. A comparison is then performed by the location server 140 at step 1112 of the received location data with the stored device data so as to determine document processing devices 104, 114, and/or 124 in physical proximity to the data processing device 146. A determination is then made at step 1114 whether all document processing devices 104, 114, and 124 are available based upon their communicated status. Upon a negative determination at step 1114, flow proceeds to step 1116, whereupon the unavailable devices 104, 114, or 124 are removed by the location server 140 for consideration.

After determining that the status of all document processing devices 104, 114, and/or 124 indicates the respective device is available, or after removal of unavailable devices, flow proceeds to step 1118. At step 1118, the location server 140 generates document processing device list data based upon the location data communicated by the data processing device 146 and the stored device data. At step 1120, the device list data is communicated from the location server 140 to the data processing device 146. A display representing the document processing device list data is then generated on the user interface associated with the data processing device 146 at step 1122. Thereafter, a map representing the document processing device list data is generated at step 1124 on the user interface of the data processing device 146. In accordance with one embodiment of the subject application, the map data is generated via interaction with a map database stored on the data storage device 142 associated with the location server 140, such that the server 140 provides such map data to the data processing device 146. Following map generation on the user interface of the data processing device 146, the user is capable of selecting a desired device 104, 114, or 124 based upon its availability and location for document processing operations.

Turning now to FIGS. 12 and 13, there is shown an example implementation of the subject system and method. It will be appreciated by those skilled in the art that such an example implementation Referring now to FIG. 12, there is shown a flowchart 1200 illustrating a method for configuring one of the document processing devices 104, 114, and 124 in accordance with one example embodiment of the subject application. In accordance with such an embodiment, the administrator or service provider must first configure the document processing device 104, 114, or 124 with the address of the MFP building at step 1202. At step 1204, the administrator inputs the location of document processing device 104, 114, or 124 in the building, e.g. floor, department, etc. Thereafter, at step 1206, the administrator inputs the network address, i.e. the IP address, of the location server 140.

Turning now to FIG. 13, there is illustrated a flowchart 1300 depicting a method for locating one of the document processing devices 104, 114, and 124 in accordance with one example embodiment of the subject application.

The location methodology of FIG. 13 begins at step 1302, whereupon the user, via the portable telecommunications device 146 or 152, which are equipped with global positioning system capabilities, connect to the location server 140. A determination is then made at step 1304 whether the location server 140 is publicly accessible, i.e. unrestricted access. In the event that the server 140 is a secure server, flow proceeds to step 1306, whereupon the user/telecommunications device 146 or 152 communicates credentials (username/password, certificate, or the like) the location server 140. The location server then determines, at step 1308, whether or not the credentials supplied by the user are valid. If invalid, the portable telecommunications device 146 or 152 is denied access to the server 140 and the methodology with respect to FIG. 13 terminates.

After validation of the user at step 1308, or upon a determination at step 1304 that the server 140 is public, flow proceeds to step 1310. At step 1310, the portable telecommunications device 146 or 152 communicates its GPS coordinates to the server 140. The location server 140 then accesses a location database 142 and, along with the received user information (GPS coordinates), determines the closest document processing device 104, 114, or 124 for that user associated with the portable telecommunications device 146 or 152 at step 1312.

After determining the closest document processing device 104, 114, or 124 to the portable device 146 or 152, the location server 140 then ascertains the current status of the closest device 104, 114, or 124 at step 1314. According to one example embodiment, this status check is accomplished via the contacting by the server 140 of a Location/Status service running on the closets document processing device 104, 114, or 124. A determination is then made at step 1316 based upon this status of whether the selected document processing device 104, 114, or 124 is functioning and available. Upon a negative determination at step 1316, operations return to step 1312, whereupon the location server 140 determines the next closest document processing device 104, 114, or 124.

Following a positive determination by the location server 140 at step 1316 that the closest document processing device 104, 114, or 124 is available, operations proceed to step 1318. At step 1318, the location server 140 sends the building address and location of the document processing device 104, 114, or 124 inside the building to the user, i.e. the portable telecommunications device 146 or 152. According to one embodiment of the subject application, the location of document processing device 104, 114, or 124 inside the building includes, for example and without limitation, floor, room number, department name, directions inside building, and the like, which are capable of being used by the user to easily find the corresponding document processing device 104, 114, or 124.

### CLOSING COMMENTS

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for document processing device location comprising:
a location server; and
a user device in communications with the location server via a network, the user device includes a user interface, at least one processor, memory, and software for performing actions including:
obtaining user location data defining a physical location of a user,
receiving, via the user interface, a user query for a location of a document processing device,
sending the user location data and the user query to the location server,
receiving, from the location server, document processing device list data, and
presenting the document processing list data to the user via the user interface, and
the location server includes at least one processor, memory, and software for performing actions including:
receiving device data corresponding to a physical location of each of a plurality of uniquely identified document processing devices,
receiving the user location data and the query from the user device,
generating the document processing device list data in accordance with a comparison of the user location data and the device data; and
sending the document processing device list data to the user.

2. The system of claim 1, wherein the device data includes status data corresponding to an operational status of each of the document processing devices.

3. The system of claim 2, wherein generating document processing device list data further comprises:
excluding data relating to document processing devices that are not available, as indicated by the corresponding status data.

4. The system of claim 1, further comprising:
a location data storage device coupled to the location server, the actions performed by the location server further including storing received device data in the location data storage device.

5. The system of claim 3 wherein obtaining user location data further comprises:
obtaining the user location data from a global positioning system receiver within the user device.

6. The system of claim 1, the actions performed by the user device further comprising:
generating a map representative of the document processing device list data; and
displaying the map on the user interface.

7. A method for document processing device location comprising:
storing, in a location data storage device, device data corresponding to a physical location of each of a plurality of uniquely identified document processing devices;
receiving user location data corresponding to a physical location of a user;
receiving, from the user, a query for a location of at least one of the document processing devices;
generating document processing device list data in accordance with a comparison of the user location data and the device data; and
sending an output representative of the document processing device list data to the user.

8. The method of claim 7 wherein the device data includes status data corresponding to an operational status of each of the document processing devices.

9. The method of claim 8, wherein generating document processing device list data further comprises:
excluding data relating to document processing devices that are not available, as indicated by the corresponding status data.

10. A server for document processing device location comprising:
at least one processor;
memory coupled to the at least one processor; and
a storage device storing instructions that, when executed, cause the server to perform actions comprising:
receiving device data corresponding to a physical location of each of a plurality of uniquely identified document processing devices,
receiving user location data defining a physical location of a user,
receiving, from the user, query for a location of a document processing device,
generating document processing device list data in accordance with a comparison of the user location data and the device data; and
sending the document processing device list data to the user.

11. The server of claim 10, wherein the device data includes status data corresponding to an operational status of each of the document processing devices.

12. The server of claim 11, wherein generating document processing device list data further comprises:
excluding data relating to document processing devices that are not available, as indicated by the corresponding status data.

13. The server of claim 12, further comprising:
a location data storage device, the actions performed further including storing received device data in the location data storage device.

14. A computing device, comprising:
at least one means for processing;
means for storing coupled to the at least one means for processing;
means for user interface coupled to the at least one means for processing; and
means for storing instructions that, when executed, cause the computing device to perform actions comprising:
obtaining user location data defining a physical location of a user,
receiving, via the means for user interface, a user query for a location of a document processing device,
sending the user location data and the user query to a location server,
receiving, from the location server, document processing device list data, and
presenting the document processing list data to the user via the means for user interface.

15. The computing device of claim 14, further comprising:
means for global positioning, such that obtaining user location data comprises obtaining the user location data from the means for global positioning.

16. The computing device of claim 14, the actions performed further comprising:
generating a map representative of the document processing device list data; and
displaying the map on the means for user interface.
